(19) United States
(12) Patent Application Publication
(10) Pub. No.: US 2025/0261295 A1
(43) Pub. Date: Aug. 14, 2025

(54) X-RAY GENERATOR

(71) Applicant: HAMAMATSU PHOTONICS K.K., Hamamatsu-shi (JP)

(72) Inventors: Atsushi ISHII, Hamamatsu-shi (JP); Tatsuya MATSUMURA, Hamamatsu-shi (JP); Naonobu SUZUKI, Hamamatsu-shi (JP); Dai HARAGUCHI, Hamamatsu-shi (JP)

(73) Assignee: HAMAMATSU PHOTONICS K.K., Hamamatsu-shi (JP)

(21) Appl. No.: 18/966,466

(22) Filed: Dec. 3, 2024

(30) Foreign Application Priority Data
Feb. 9, 2024 (JP) 2024-018704

(51) Int. Cl. H05G 1/08

(52) U.S. Cl. CPC H05G 1/08

(57) ABSTRACT

An X-ray generator includes: an X-ray tube configured to cause an X-ray beam to be generated; a source configured to generate a voltage to be applied to the X-ray tube; a container storing at least part of the X-ray tube; a first insulator that is liquid, the first insulator being sealed in the container, the first insulator covering the at least part of the X-ray tube; and a gas sensor including a detector disposed in the container to detect gas generated in the first insulator.

### TECHNICAL FIELD

The present disclosure relates to an X-ray generator.

### BACKGROUND

As an X-ray generator, known is an X-ray generator including an X-ray tube that causes an X-ray beam to be generated, a source that generates a voltage to be applied to the X-ray tube, a container that stores at least part of the X-ray tube, and a liquid insulator that is sealed in the container and covers the at least the part of the X-ray tube (see, for example, Japanese Patent No. 6190563).

### SUMMARY

In such an X-ray generator as described above, due to occurrence of discharging in the insulator, thermal decomposition of the insulator may occur. In this case, because the insulating performance of the insulator is decreased, the operational stability of the X-ray generator may be decreased. In order to maintain the operational stability of the X-ray generator, the gas derived, in the insulator, from the thermal decomposition of the insulator is detected, so that the insulating performance of the insulator is checked for the level of decrease.

An object of the present disclosure is to provide an X-ray generator that can easily detect gas generated in an insulator.

### Solution to Problem

An X-ray generator according to one aspect of the present disclosure includes: an X-ray tube configured to cause an X-ray beam to be generated; a source configured to generate a voltage to be applied to the X-ray tube; a container storing at least part of the X-ray tube; a first insulator that is liquid, the first insulator being sealed in the container, the first insulator covering the at least part of the X-ray tube; and a gas sensor including a detector disposed in the container to detect gas generated in the first insulator.

An X-ray generator according to one aspect of the present disclosure includes: an X-ray tube configured to cause an X-ray beam to be generated; a source configured to generate a voltage to be applied to the X-ray tube; a container storing at least part of the X-ray tube; and a first insulator that is liquid, the first insulator being sealed in the container, the first insulator covering the at least part of the X-ray tube, in which the container is provided with a discharge port through which an inside of the container and an outside of the container are in communication with each other.

An X-ray generator according to one aspect of the present disclosure includes: an X-ray tube configured to cause an X-ray beam to be generated; a source configured to generate a voltage to be applied to the X-ray tube; a container storing at least part of the X-ray tube; and a first insulator that is liquid, the first insulator being sealed in the container, the first insulator covering the at least part of the X-ray tube, in which at least part of the container is made of a material that allows light having a predetermined wavelength to travel through the material.

### BRIEF DESCRIPTION OF THE DRAWINGS

FIG. 1 is a sectional view of an X-ray generator according to a first embodiment;

FIG. 2 is a sectional view of an X-ray generator according to a second embodiment;

FIG. 3 is a sectional view of an X-ray generator according to a third embodiment;

FIG. 4 is a sectional view of an X-ray generator according to a modification; and

FIG. 5 is a sectional view of an X-ray generator according to another modification.

### DETAILED DESCRIPTION

Hereinafter, embodiments of the present disclosure will be described in detail with reference to the accompanying drawings. In the drawings, the same or corresponding parts are denoted by the same reference signs, and redundant description will be not be given.

### X-ray Generator of First Embodiment

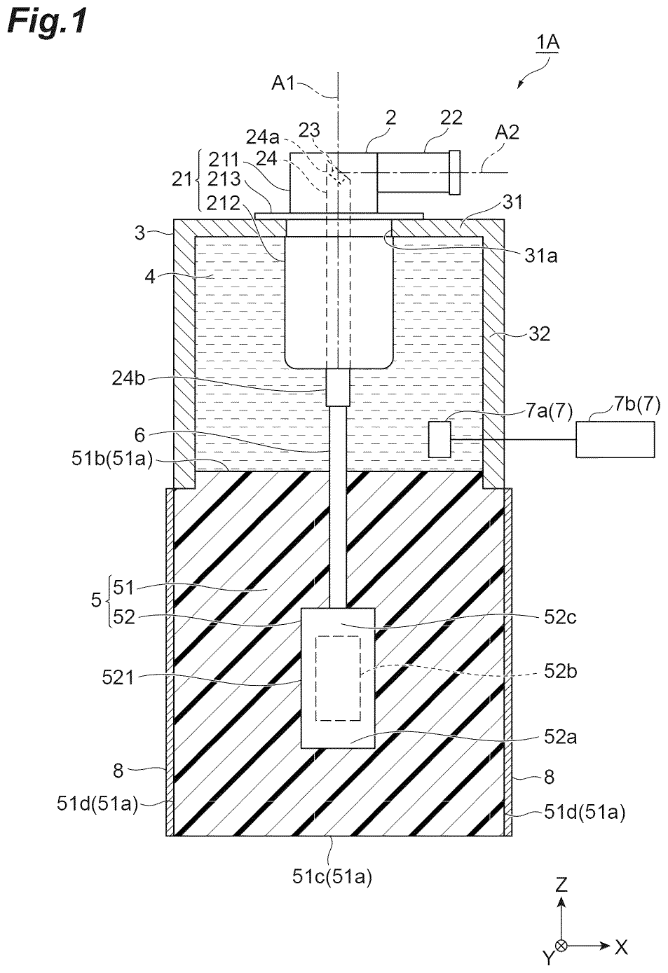

As illustrated in FIG. 1, an X-ray generator 1A of a first embodiment includes an X-ray tube 2, a container 3, a first insulator 4, a source 5, a conductive member 6, a gas sensor 7, and a conductive paint 8. The X-ray generator 1A is, for example, a microfocus X-ray source to be used for X-ray non-destructive inspection.

The X-ray tube 2 is a vacuum tube for generating an X-ray beam. The X-ray tube 2 includes a housing 21, an electron gun 22, a target 23, and an anode 24. The housing 21 houses the electron gun 22, the target 23, and the anode 24. The space in the housing 21 is a space to be evacuated. The housing 21 includes a head 211, a valve 212, and a flange 213. The head 211 made of a metal material such as stainless steel has a bottomed cylindrical shape. The valve 212 made of an insulating material such as glass has a bottomed cylindrical shape. The head 211 is airtightly joined to the valve 212 such that the inside of the head 211 is in communication with the inside of the valve 212. The flange 213 made of a metal material such as stainless steel has an annular shape along the outer edge of the head 211. Here, a direction along the central axis (pipe axis) A1 of the valve 212 is referred to as a Z-axis direction, a direction perpendicular to the Z-axis direction is referred to as an X-axis direction, and a direction perpendicular to both the Z-axis direction and the X-axis direction is referred to as a Y-axis direction.

The electron gun 22 emits an electron beam to the target 23 in the housing 21. The electron gun 22 includes a hot cathode that emits thermoelectrons, an anode that accelerates electrons, and an electron lens that adjusts convergence of an electron beam (all not illustrated), for example. The electron gun 22 is fixed to the head 211 such that the central axis A2 of the electron gun 22 is orthogonal to the central axis A1 of the valve 212. The central axis A2 of the electron gun 22 is along the X-axis direction.

The target 23 generates an X-ray beam in the housing 21, in response to incidence of the electron beam emitted from the electron gun 22 on the target 23. The target 23 made of a high melting point metal material such as tungsten has a plate shape. The target 23 is supported by the anode 24 in the housing 21 so as to face the electron gun 22 in the X-axis direction.

The anode 24 applies a voltage generated by the source 5 to the target 23. Therefore, the anode 24 is in conduction with the target 23. The anode 24 made of a metal material such as copper has a rod shape extending along the Z-axis direction. The anode 24 extends from the outside of the housing 21 to the inside of the housing 21 such that the central axis of the anode 24 coincides with the central axis A1 of the valve 212. The anode 24 is fixed to the bottom of the valve 212. The anode 24 has a leading end face in the housing 21, and the leading end face is an inclined face inclined to both the central axis A1 and the central axis A2. The anode 24 has a leading end portion 24a, and the target 23 is embedded in the leading end portion 24a such that the target 23 is flush with the leading end face of the anode 24.

The container 3 houses part of the X-ray tube 2. In the X-ray generator 1A of the first embodiment, the container 3 houses the valve 212. The container 3 made of a metal material such as aluminum has a bottomed cylindrical shape. The container 3 has an upper portion 31 and a side portion 32. The side portion 32 has a tubular shape with the Z-axis direction as a height direction. The side portion 32 has one end portion (an upper end portion in the present embodiment) in the Z-axis direction, and the upper portion 31 occludes the one end portion. The upper portion 31 is provided with an opening 31a. The X-ray tube 2 is located inside the opening 31a. The flange 213 is fixed to the upper portion 31 with the valve 212 located inside the container 3. The side portion 32 has the other end portion (a lower end portion in the present embodiment) in the Z-axis direction is fixed to the upper end of the source 5 (an upper face 51b that a second insulator 51 has). The first insulator 4 is sealed in the container 3.

The first insulator 4 electrically insulates the X-ray tube 2 from other members. The first insulator 4 is a liquid insulator. The first insulator 4 is, for example, an insulating oil containing mineral oil or ester oil as a main component. The first insulator 4 covers, in the container 3, the valve 212, part of the anode 24 exposed outward from the housing 21, and part of the conductive member 6 exposed outward from the second insulator 51. In the X-ray generator 1A of the first embodiment, the inside of the container 3 is filled with the first insulator 4.

The source 5 generates a voltage to be applied to the target 23 through the conductive member 6 and the anode 24. The source 5 is disposed on one side of location in the Z-axis direction with respect to the housing 21 (below the housing 21). The source 5 is aligned with the X-ray tube 2 along the Z-axis direction. The source 5 includes the second insulator 51 and a circuit 52.

The second insulator 51 is a solid insulator that electrically insulates the circuit 52 from other members. The second insulator 51 made of a resin material such as epoxy resin has a rectangular parallelepiped shape. The second insulator 51 has a surface 51a including the upper face 51b as a face on the side of location of the housing 21, a lower face 51c opposed to the upper face 51b, and a side face 51d connecting the upper face 51b and the lower face 51c to each other. Part of the upper face 51b rises. The part is in contact with the first insulator 4 in the container 3. The conductive paint 8 is applied to the side face 51d of the second insulator 51, and the potential of the side face 51d is set as the ground potential.

The circuit 52 includes a substrate 521 as a rectangular printed circuit board. The substrate 521 has a front face orthogonal to the Y-axis direction. A first voltage section 52a, a booster 52b, and a second voltage section 52c are mounted on the front face of the substrate 521. The first voltage section 52a is an input terminal that receives a first voltage from the outside, and is electrically connected to the booster 52b. The booster 52b boosts the first voltage to a second voltage. The booster 52b is, for example, a Cockcroft-Walton multiplier. The second voltage section 52c is an output terminal that outputs the second voltage to the target 23 through the conductive member 6 and the anode 24, and is electrically connected to the booster 52b.

The booster 52b is located in a central portion of the front face of the substrate 521. The first voltage section 52a is located on one side of location in the Z-axis direction with respect to the booster 52b (lower face 51c side). The second voltage section 52c is located on the other side of location in the Z-axis direction with respect to the booster 52b (upper face 51b side).

The circuit 52 is embedded in the second insulator 51 such that the entirety of the circuit 52 is located in the second insulator 51. The circuit 52 is embedded in the second insulator 51 such that the substrate 521 extends straight along the Z-axis direction.

The conductive member 6 electrically connects the second voltage section 52c and the target 23 through the anode 24. Therefore, the conductive member 6 is conductive. The conductive member 6 made of a metal material such as aluminum has a rod shape. The conductive member 6 has an end portion electrically connected to the second voltage section 52c, and another end portion electrically connected to a base end portion 24b that the anode 24 has (a portion of the anode 24 located outside the housing 21). The conductive member 6 is embedded in the second insulator 51 such that part of the conductive member 6 is located in the second insulator 51. Part of the conductive member 6 different from the part of the conductive member 6 embedded in the second insulator 51 is exposed outward from the second insulator 51. The part of the conductive member 6 exposed outward from the second insulator 51 is electrically connected to the base end portion 24b of the anode 24 inside the container 3.

The gas sensor 7 detects gas generated in the first insulator 4. The gas sensor 7 has a configuration corresponding to the type of gas to be detected. The gas sensor 7 includes a detector 7a and a controller 7b. The controller 7b functions as, for example, a voltage applier that applies a voltage for driving the detector 7a and a signal processor that processes a detection signal from the detector 7a. The detector 7a is disposed in the container 3. In the X-ray generator 1A of the first embodiment, the detector 7a is disposed in the first insulator 4. That is, the detector 7a is immersed in the first insulator 4. The detector 7a is electrically connected to the controller 7b disposed outside the container 3. The controller 7b may be disposed in the source 5. For example, the controller 7b may be mounted on the substrate 521. Alternatively, the controller 7b may be mounted on a substrate different from the substrate 521, and the substrate may be embedded in the second insulator 51.

The gas sensor 7 is, for example, a non dispersive infrared (NDIR) gas sensor. The NDIR gas sensor detects gas by utilizing a property that gas molecules absorb infrared light having a specific wavelength. The detector 7a of the gas sensor 7 as an NDIR gas sensor includes a light emitter and a light receiver. The light emitter is a light emitting element that emits infrared light having a specific wavelength, and is electrically connected to the controller 7b. The light receiver is a light receiving element that absorbs infrared light emitted from the light emitter, and is electrically connected to the controller 7b. The light receiver outputs a signal corresponding to the amount of absorbed infrared light to the controller 7b. In a case where gas (e.g., acetylene gas) is present in the first insulator 4, the infrared light to the light receiver is reduced in amount because a portion of infrared light emitted from the light emitter is absorbed by the gas. The controller 7b calculates the concentration of the gas on the basis of the level of the signal detected through the light receiver. In a case where the gas to be detected is acetylene gas, the light emitter emits infrared light with a wavelength of, for example, 2.9 μm or more and 3.1 μm or less. The infrared light is infrared light that has a molecular structure unique to acetylene and that can be absorbed by acetylene gas.

The gas sensor 7 may be a gas sensor different from the NDIR gas sensor. For example, the gas sensor 7 may be a semiconductor gas sensor including a detector 7a having a substrate layer, a semiconductor layer, a gate electrode, and an ohmic contact. The substrate layer is a substrate made of, for example, sapphire. The semiconductor layer is formed on the substrate layer by epitaxial growth. The gate electrode and the ohmic contact are deposited on the semiconductor layer. The gate electrode is made of a metal material such as platinum. The ohmic contact is, for example, a Ti/Al layer or a Ti/Pt/Au layer formed by electron beam evaporation. A controller 7b is electrically connected to each of the gate electrode and the ohmic contact. In case where gas (e.g., hydrogen gas) is generated in the first insulator 4, the hydrogen gas is adsorbed to the gate electrode, whereby the hydrogen molecules are dissociated into hydrogen atoms. The hydrogen atoms reach the interface between the gate electrode and the semiconductor layer through the gate electrode. As a result, the height of the Schottky barrier at the interface changes, so that the resistance value between the gate electrode and the ohmic contact changes. The controller 7b causes a constant voltage to be applied between the gate electrode and the ohmic contact to measure a change in the current flowing between the gate electrode and the ohmic contact. Alternatively, the controller 7b may cause a constant current to flow between the gate electrode and the ohmic contact to measure a change in the voltage between the gate electrode and the ohmic contact. The amount of change in the height of the Schottky barrier increases as the concentration of the gas increases. Taking this advantage, the controller 7b may calculate the concentration of the gas in the first insulator 4.

The detector 7a of the gas sensor 7 is disposed in the container 3 so as not to overlap the part of the X-ray tube 2 stored in the container 3 when viewed in any of the Z-axis direction and directions perpendicular to the Z-axis direction. For example, the detector 7a does not overlap the valve 212 and the part of the anode 24 exposed outward from the housing 21 when viewed in any of the X-axis direction, the Y-axis direction, and the Z-axis direction. The shortest distance between the detector 7a and the X-ray tube 2 is larger than the shortest distance between the detector 7a and the side portion 32. The shortest distance between the detector 7a and the X-ray tube 2 is larger than the shortest distance between the detector 7a and the second insulator 51. The shortest distance between the detector 7a and the conductive member 6 is larger than the shortest distance between the detector 7a and the side portion 32. The shortest distance between the detector 7a and the conductive member 6 is larger than the shortest distance between the detector 7a and the second insulator 51.

In the present embodiment, the target 23 embedded in the leading end portion 24a of the anode 24 is located outside the container 3, whereas the detector 7a is disposed in the container 3. With this arrangement, the X-ray beam generated from the target 23 can be prevented from adversely affecting the detector 7a.

In the X-ray generator 1A having the configuration as described above, with the side face 51d of the second insulator 51 set as the ground potential, for example, several hundreds of voltages (V) as a first voltage are received by the first voltage section 52a from an external source device. The booster 52b boosts the first voltage to a second voltage of several kilovolts (kV) to several hundreds of kilovolts (kV), for example. Then, the second voltage section 52c outputs the second voltage to the target 23 through the conductive member 6 and the anode 24. In response to incidence of an electron beam on the target 23 from the electron gun 22 with the second voltage applied to the target 23, an X-ray beam is generated from the target 23. The X-ray generator 1A is a so-called sealed reflection type X-ray generator. A negative voltage applied to the electron gun 22 may be performed by a transformer (not illustrated) included in the source 5 or by the circuit 52.

As described above, in the X-ray generator 1A, the second voltage generated by the source 5 is applied to the target 23 (X-ray tube 2). In response to the application of the second voltage to the X-ray tube 2, discharging may occur in the first insulator 4. In a case where the first insulator 4 is an insulating oil containing mineral oil or ester oil as a main component, thermal decomposition of the first insulator 4 occurs due to the discharging. In response to the thermal decomposition due to the discharging, a decomposition product is generated with the generation of acetylene gas or hydrogen gas. As the amount of the decomposition product increases in first insulator 4, the insulating performance of the first insulator 4 decreases. Both the acetylene gas and the hydrogen gas are gases characteristic of thermal decomposition caused by discharging. According to the X-ray generator 1A, detection of the acetylene gas or the hydrogen gas by the gas sensor 7 enables indirectly check of the presence or absence of the abnormal phenomenon (discharging) in the first insulator 4 and the level of decrease of the insulating performance.

As described above, in the X-ray generator 1A, the detector 7a is disposed in the container 3 with the first insulator 4 that is liquid sealed therein. The detector 7a included in the gas sensor 7 can detect the gas generated in the first insulator 4. Therefore, according to the X-ray generator 1A, the gas generated in the first insulator 4 can be easily detected.

In the X-ray generator 1A, the detector 7a is disposed in the first insulator 4. Because the detector 7a is disposed in the first insulator 4 that is a gas generation source, the gas generated in the first insulator 4 can be efficiently detected. Thus, the gas generated in the first insulator 4 can be easily and efficiently detected.

In the X-ray generator 1A, the detector 7a is disposed in the container 3 so as not to overlap the part of the X-ray tube 2 stored in the container 3 when viewed in any of the Z-axis direction and the directions (e.g., the X-axis direction and the Y-axis direction) perpendicular to the Z-axis direction. With this arrangement, discharging between the X-ray tube 2 and the detector 7a can be prevented.

In the X-ray generator 1A, the source 5 includes the second insulator 51 and the circuit 52 embedded in the second insulator 51. The circuit 52 includes the first voltage section 52a that receives the first voltage from the outside, the booster 52b that boosts the first voltage to the second voltage, and the second voltage section 52c that outputs the second voltage to the X-ray tube 2. With this arrangement, the circuit 52 is insulated from other members by the second insulator 51. Therefore, because occurrence of discharging in the source 5 can be prevented, the operational stability of the X-ray generator 1A can be improved.

### X-ray Generator of Second Embodiment

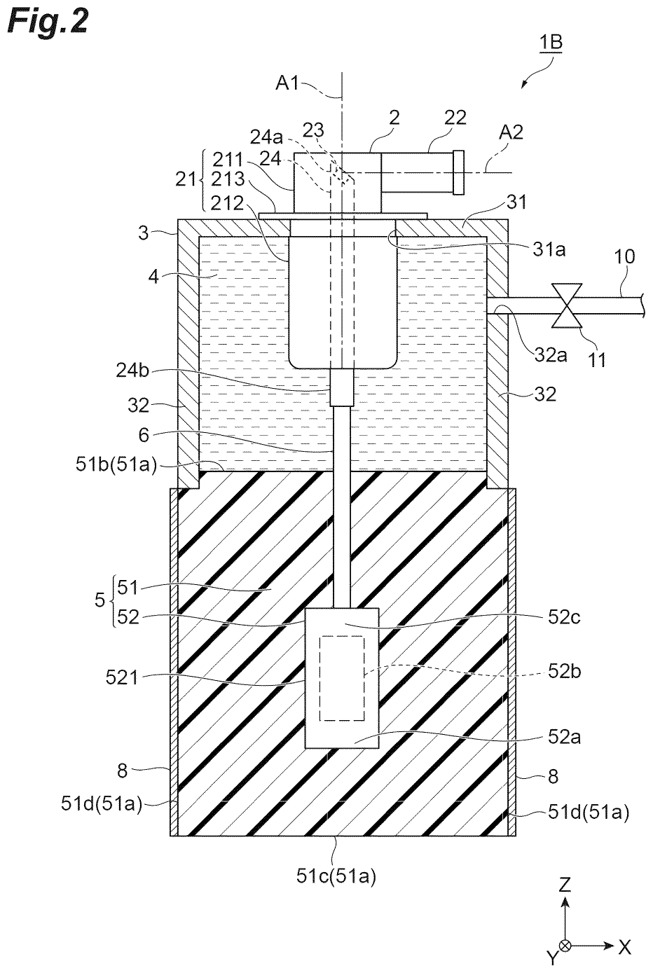

As illustrated in FIG. 2, an X-ray generator 1B of a second embodiment is mainly different from the X-ray generator 1A of the first embodiment in that the X-ray generator 1B includes a pipe 10 and an open and shut part 11. Hereinafter, the X-ray generator 1B of the second embodiment will be described focusing on such differences from the X-ray generator 1A of the first embodiment. The X-ray generator 1B further includes the pipe 10 and the open and shut part 11.

The container 3 has an upper portion 31 and a side portion 32. The side portion 32 has a tubular shape with the Z-axis direction as a height direction. The side portion 32 has one end portion (an upper end portion in the present embodiment) in the Z-axis direction, and the upper portion 31 occludes the one end portion. The side portion 32 is provided with a discharge port 32a through which the inside of the container 3 and the outside of the container 3 are in communication with each other.

The pipe 10 is a cylindrical member for taking out a first insulator 4 in the container 3 to the outside of the container 3. The pipe 10 is made of a metal material such as stainless steel. The pipe 10 is connected to the discharge port 32a such that the inside of the pipe 10 is in communication with the inside of the container 3. The pipe 10 is liquid-tightly connected to the discharge port 32a such that the first insulator 4 does not leak from between the pipe 10 and the discharge port 32a. The first insulator 4 is taken out to the outside of the container 3 through the discharge port 32a and the pipe 10.

The open and shut part 11 is a member that adjusts the flow of the first insulator 4 in the pipe 10. The open and shut part 11 is provided to the pipe 10 and brings the inside of the pipe 10 into an open state or a shut state. The open and shut part 11 is a valve such as a manual valve, an electric valve, or a solenoid valve.

In the X-ray generator 1B having the configuration as described above, with the open and shut part 11 open, part of the first insulator 4 in the container 3 can be taken out to the outside of the container 3 through the discharge port 32a and the pipe 10. The taken-out part of the first insulator 4 is analyzed with an analyzer such as gas chromatography, so that gas generated in the first insulator 4 can be detected.

As described above, in the X-ray generator 1B, the container 3 with the first insulator 4 that is liquid sealed therein is provided with the discharge port 32a through which the inside of the container 3 and the outside of the container 3 is in communication with each other. With this arrangement, the first insulator 4 can be easily taken out from the inside of the container 3 through the discharge port 32a. Then, the first insulator 4 having been taken out is analyzed, so that the gas generated in the first insulator 4 can be detected. Therefore, according to the X-ray generator 1B, the gas generated in the first insulator 4 can be easily detected.

The X-ray generator 1B includes the pipe 10 connected to the discharge port 32a, and the open and shut part 11 that is provided to the pipe 10 and brings the inside of the pipe 10 into the open state or the shut state. With this arrangement, it is easily achievable that leakage of the first insulator 4 from the container 3 is prevented while the first insulator 4 is taken out from the container 3 through the discharge port 32a.

### X-ray Generator of Third Embodiment

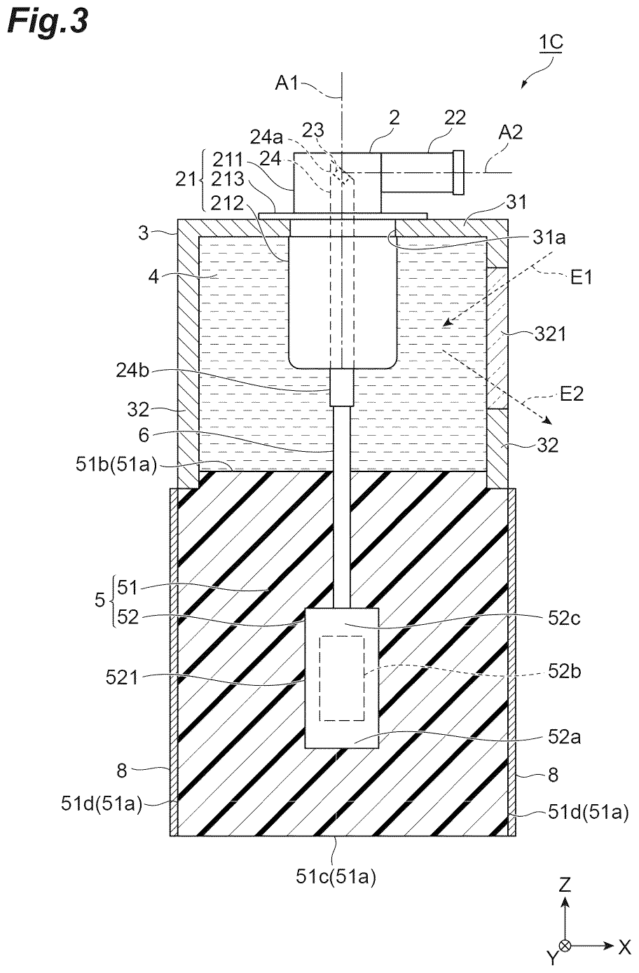

As illustrated in FIG. 3, an X-ray generator 1C of a third embodiment is mainly different from the X-ray generator 1A of the first embodiment in that at least part of a container 3 is made of a material that allows light having a predetermined wavelength to travel through the material. Hereinafter, the X-ray generator 1C of the third embodiment will be described focusing on such differences from the X-ray generator 1A of the first embodiment.

The container 3 has an upper portion 31 and a side portion 32. The side portion 32 has a tubular shape with the Z-axis direction as a height direction. The side portion 32 has one end portion (an upper end portion in the present embodiment) in the Z-axis direction, and the upper portion 31 occludes the one end portion.

A part 321 of the side portion 32 is made of a material that allows light having a predetermined wavelength to travel through the material. The part 321 has a circular shape, for example. The material of the part 321 is appropriately selected in accordance with a predetermined wavelength value. The range of predetermined wavelength is, for example, 2.5 μm or more and 25 μm or less in a case where infrared spectroscopy is used. In order to have transparency to light in this wavelength band, the part 321 is made of an infrared light transmitting material such as quartz glass, diamond, sapphire, silicon, or germanium. A part of the side portion 32 different from the part 321 thereof is made of a metal material such as stainless steel or aluminum.

In the X-ray generator 1C having the configuration as described above, gas generated in a first insulator 4 is detected as follows. First, incident light E1 emitted from a light source (not illustrated) travels toward the part 321. The incident light E1 has a predetermined wavelength. The incident light E1 enters the inside of the container 3 from the outside of the container 3 through the part 321. A portion of the incident light E1 is reflected as reflected light E2 containing chemical information regarding the first insulator 4. The reflected light E2 is acquired, for example, as follows. That is, the incident angle of the incident light E1 and the refractive index of a material constituting the first insulator 4 and the material constituting the part 321 are adjusted so as to satisfy the total reflection condition at the interface (contact face) between the first insulator 4 and the part 321. Then, the incident light E1 totally reflected at the interface is acquired as the reflected light E2. Alternatively, a reflector is disposed so as to reflect the incident light E1 toward the part 321 inside the first insulator 4, so that the incident light E1 reflected by the reflector is acquired as the reflected light E2. At least a portion of the reflected light E2 is emitted to the outside of the container 3 through the part 321. The absorption (transmission) spectrum obtained from the incident light E1 and the reflected light E2 changes proportionally in accordance with the amount of gas generated in the first insulator 4 (the amount of gas present in the first insulator 4). The reflected light E2 is detected with a photodetector (not illustrated) to analyze the obtained absorption spectrum. As a result, the type and the abundance of the gas generated in the first insulator 4 can be estimated. Here, in order to measure acetylene gas present in the first insulator 4, focusing on the peak due to the presence of the acetylene gas observed in the wavelength region of 2.9 μm or more and 3.1 μm or less including the characteristic absorption band of acetylene, the peak intensity and the temporal changes in the peak intensity are examined. As a result, the abundance and the increasing tendency of the acetylene gas generated in the first insulator 4 can be estimated. Therefore, according to the X-ray generator 1C, the degree of progress in deterioration of the first insulator 4 can be estimated on the basis of the abundance and the increasing tendency of the acetylene gas. Further, in addition to the peak intensity of acetylene, the peak intensity due to the presence of ethane gas observed in the wavelength region of 3.3 μm or more and 3.5 μm or less is obtained by a similar method. As a result, the abundance ratio of acetylene and ethane can be calculated. On the basis of the obtained abundance ratio, it can be presumed that the thermal decomposition due to discharging is dominant when the abundance of acetylene is larger, whereas the thermal decomposition due to overheating is dominant when the abundance of ethane is larger. In such a manner, whether the deterioration of the first insulator 4 is caused by discharging or overheating can be isolated.

As described above, in the X-ray generator 1C, the part 321 of the container 3 (side portion 32) is made of the material that allows the light having the predetermined wavelength to travel through the material. With this arrangement, the light having the predetermined wavelength is allowed to enter the first insulator 4 in the container 3 through the part 321, so that reflected light from the first insulator 4 can be easily acquired. The absorption spectrum obtained from the reflected light is analyzed, so that the gas generated in the first insulator 4 can be detected. Therefore, according to the X-ray generator 1C, the gas generated in the first insulator 4 can be easily detected.

### Modifications

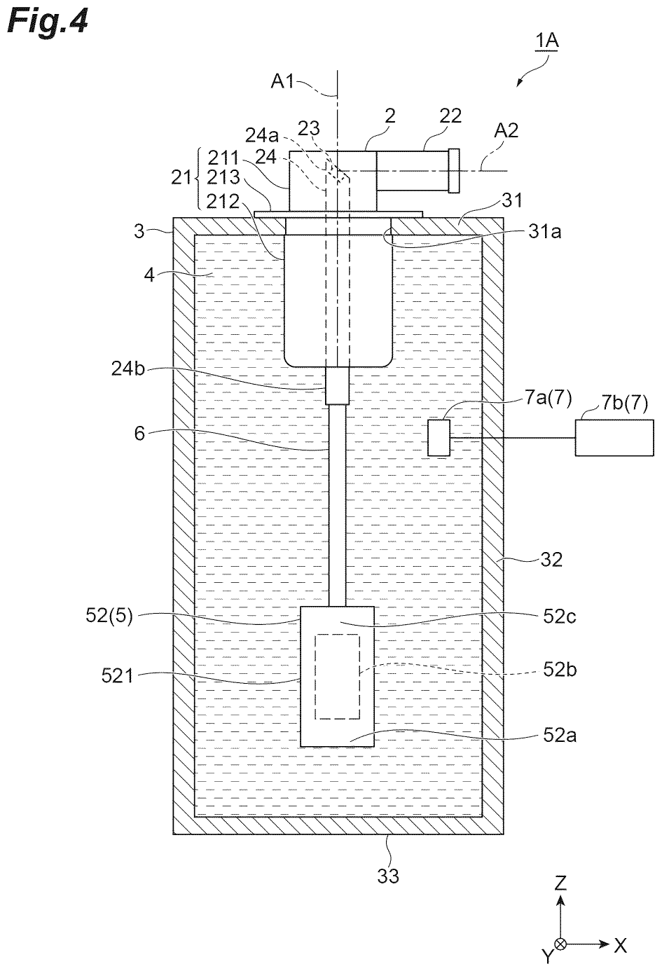

The present disclosure is not limited to the above embodiments. In the X-ray generator 1A of the first embodiment, the container 3 stores the at least part of the X-ray tube 2, but the aspect of the container 3 is not limited thereto. For example, as illustrated in FIG. 4, in an X-ray generator 1A, a container 3 may further store a circuit 52, and a first insulator 4 may further cover the circuit 52. The container 3 may further include a lower portion 33 that occludes another end portion (a lower end portion in the present embodiment) of a side portion 32 in the Z-axis direction. In this case, each of an X-ray tube 2 and the circuit 52 can be easily insulated from other members by a single type of the first insulator 4. Gas can be easily detected also for the first insulator 4 having such a configuration as described above. Also in the X-ray generator 1B of the second embodiment and the X-ray generator 1C of the third embodiment, the container 3 may further store the circuit 52, and the first insulator 4 may further cover the circuit 52.

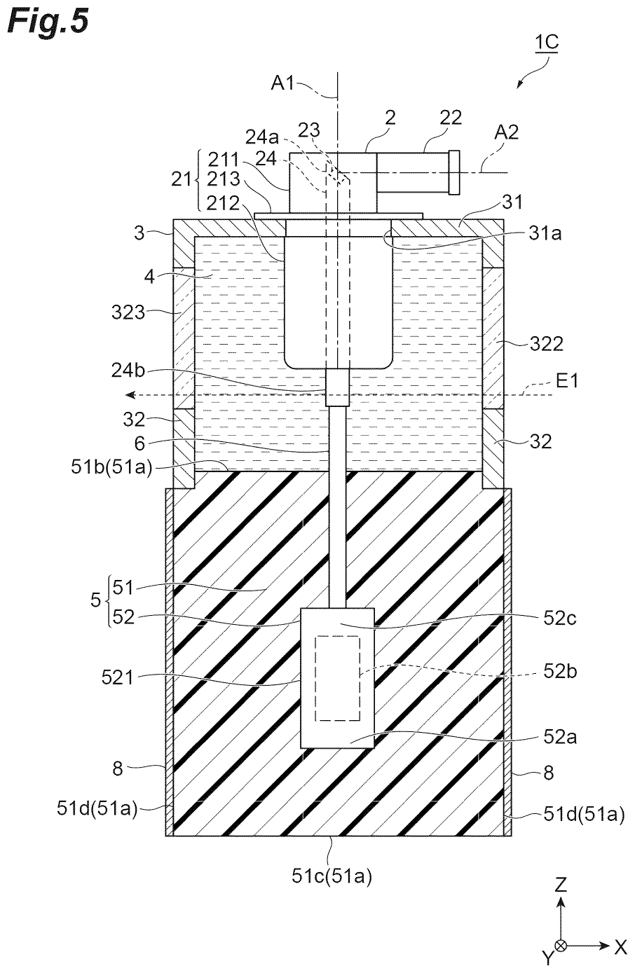

In the X-ray generator 1C of the third embodiment, the part 321 of the container 3 is made of the material that allows the light having the predetermined wavelength to travel through the material, but the aspect of the container 3 is not limited thereto. For example, as illustrated in FIG. 5, in an X-ray generator 1C, a side portion 32 includes a part 322 and a part 323. The parts 322 and 323 may be each made of a material that allows light having a predetermined wavelength to travel through the corresponding material. The parts 322 and 323 may be located on both side of a first insulator 4 in the X-axis direction (predetermined direction). In this case, the transmitted light traveling along the X-axis direction can be more easily acquired through the parts 322 and 323 located on both sides of the first insulator 4. Specifically, incident light E1 traveling along the X-axis direction enters the inside of a container 3 through the part 322. A portion of the incident light E1 is absorbed by the first insulator 4, and other portions of the incident light E1 are emitted to the outside of the container 3 as transmitted light through the part 323. The absorption (transmission) spectrum obtained from the transmitted light and the incident light E1 changes in accordance with the amount (abundance) of gas generated in the first insulator 4. Therefore, the transmitted light is analyzed, so that the gas generated in the first insulator 4 can be detected and further the type and the abundance of the gas can be estimated. In the X-ray generator IC, the container 3 may include three or more parts each made of a material that allows light having a predetermined wavelength to travel through the corresponding material.

In the X-ray generator 1A of the first embodiment, the inside of the container 3 is filled with the first insulator 4, but part of the inside of the container 3 is not necessarily filled with the first insulator 4. In this case, the detector 7a may be disposed in the container 3 so as not to contact the first insulator 4.

In the X-ray generator 1C of the third embodiment, the part 321 of the container 3 is made of the material that allows the light having the predetermined wavelength to travel through the material, but in the X-ray generator 1C, the entirety of the container 3 may be made of a material that allows light having a predetermined wavelength to travel through the material.

The X-ray generator 1B of the second embodiment includes the pipe 10 and the open and shut part 11, but the X-ray generator 1B does not necessarily include the pipe 10 and the open and shut part 11. In this case, the X-ray generator 1B may include an open and shut part (e.g., a lid) that brings the discharge port 32a into an open state or a shut state.

In the X-ray generator 1B of the second embodiment, the open and shut part 11 is a manual valve, a solenoid valve, or an electric valve, but the open and shut part 11 may be, for example, a lid as long as the inside of the pipe 10 is brought into an open state or a shut state.

In the X-ray generator 1A of the first embodiment, the X-ray generator 1B of the second embodiment, and the X-ray generator 1C of the third embodiment, the container 3 stores the valve 212, but the container 3 may stores at least part of the X-ray tube 2.

The X-ray generator 1A of the first embodiment, the X-ray generator 1B of the second embodiment, and the X-ray generator 1C of the third embodiment are sealed reflection type X-ray generators. However, each of the X-ray generators 1A, 1B, and 1C may be a sealed transmission type X-ray generator.

An X-ray generator according to one aspect of the present disclosure is [1] “an X-ray generator including: an X-ray tube configured to cause an X-ray beam to be generated; a source configured to generate a voltage to be applied to the X-ray tube; a container storing at least part of the X-ray tube; a first insulator that is liquid, the first insulator being sealed in the container, the first insulator covering the at least part of the X-ray tube; and a gas sensor including a detector disposed in the container to detect gas generated in the first insulator”.

In the X-ray generator described in [1], the detector of the gas sensor is disposed in the container with the first insulator that is liquid sealed therein. The gas sensor can detect the gas generated in the first insulator. Therefore, according to the X-generator described in [1], the gas generated in the first insulator can be easily detected.

An X-ray generator according to one aspect of the present disclosure may be [2] “the X ray generator according to [1], in which the detector is disposed in the first insulator”. According to the X-ray generator described in [2], because the detector of the gas sensor is disposed in the first insulator that is a gas generation source, the gas generated in the first insulator can be efficiently detected. Thus, the gas generated in the first insulator can be easily and efficiently detected.

An X-ray generator according to one aspect of the present disclosure may be [3] “the X-ray generator according to [1] or [2], in which the detector is disposed in the container such that the detector does not overlap the at least part of the X-ray tube when viewed in any of a predetermined direction in which the at least part of the X-ray tube and the source are aligned and directions perpendicular to the predetermined direction”. According to the X-ray generator described in [3], occurrence of discharging between the at least part of the X-ray tube and the detector of the gas sensor can be prevented.

An X-ray generator according to one aspect of the present disclosure may be [4] “an X-ray generator including: an X-ray tube configured to cause an X-ray beam to be generated; a source configured to generate a voltage to be applied to the X-ray tube; a container storing at least part of the X-ray tube; and a first insulator that is liquid, the first insulator being sealed in the container, the first insulator covering the at least part of the X-ray tube, in which the container is provided with a discharge port through which an inside of the container and an outside of the container are in communication with each other”.

In the X-ray generator according to [4], the container with the first insulator that is liquid sealed therein is provided with the discharge port through which the inside of the container and the outside of the container is in communication with each other. With this arrangement, the first insulator can be taken out from the inside of the container through the discharge port. Then, the first insulator having been taken out is analyzed, so that gas generated in the first insulator can be detected. Therefore, according to the X-generator described in [4], the gas generated in the first insulator can be easily detected.

An X-ray generator according to one aspect of the present disclosure may be [5] “the X-ray generator according to [4], further including: a pipe connected to the discharge port; and an open and shut part provided to the pipe, the open and shut part being configured to bring an inside of the pipe into an open state or a shut state”. According to the X-ray generator described in [5], it is easily achievable that leakage of the first insulator from the container is prevented while the first insulator is taken out from the inside of the container through the discharge port.

An X-ray generator according to one aspect of the present disclosure is [6] “an X-ray generator including: an X-ray tube configured to cause an X-ray beam to be generated; a source configured to generate a voltage to be applied to the X-ray tube; a container storing at least part of the X-ray tube; and a first insulator that is liquid, the first insulator being sealed in the container, the first insulator covering the at least part of the X-ray tube, in which at least part of the container is made of a material that allows light having a predetermined wavelength to travel through the material”.

In the X-ray generator according to [6], the at least the part of the container is made of the material that allows the light having the predetermined wavelength to travel through the material. With this arrangement, light having a predetermined wavelength is allowed to be incident on the first insulator in the container through the at least part of the container. As a result, for example, transmitted light and reflected light from the first insulator can be easily acquired. These transmitted light and reflected light are analyzed, so that gas generated in the first insulator can be detected. Therefore, according to the X-generator described in [6], the gas generated in the first insulator can be easily detected.

An X-ray generator according to one aspect of the present disclosure may be [7] “the X-ray generator according to [6], in which the at least part of the container includes a plurality of parts located on both sides of the first insulator in a predetermined direction”. According to the X-ray generator described in [7], transmitted light traveling along the predetermined direction can be more easily acquired through the plurality of parts located on both sides of the first insulator.

An X-ray generator according to one aspect of the present disclosure may be [8] “the X-ray generator according to any one of [1] to [7], in which the source includes: a second insulator; and a circuit embedded in the second insulator, and the circuit includes: a first voltage section configured to receive a first voltage from outside; a booster configured to boost the first voltage to a second voltage as the voltage; and a second voltage section configured to output the second voltage to the X-ray tube”. According to the X-ray generator described in [8], the circuit is insulated from other members by the second insulator. With this arrangement, occurrence of discharging in the source can be prevented, so that the operational stability of the X-ray generator can be improved.

An X-ray generator according to one aspect of the present disclosure may be [9] “the X-ray generator according to any one of [1] to [7], in which the source includes a circuit including: a first voltage section configured to receive a first voltage from outside; a booster configured to boost the first voltage to a second voltage as the voltage; and a second voltage section configured to output the second voltage to the X-ray tube, the container further stores the circuit, and the first insulator further covers the circuit”. According to the X-ray generator described in [9], each of the X-ray tube and the circuit can be easily insulated from other members by a single type of the first insulator. Gas can be easily detected also for the first insulator having such a configuration as described above.

According to the present disclosure, provided can be an X-ray generator that can easily detect gas generated in an insulator.

What is claimed is:

1. An X-ray generator comprising:
an X-ray tube configured to cause an X-ray beam to be generated;
a source configured to generate a voltage to be applied to the X-ray tube;
a container storing at least part of the X-ray tube;
a first insulator that is liquid, the first insulator being sealed in the container, the first insulator covering the at least part of the X-ray tube; and
a gas sensor including a detector disposed in the container to detect gas generated in the first insulator.

2. The X-ray generator according to claim 1, wherein the detector is disposed in the first insulator.

3. The X-ray generator according to claim 1, wherein the detector is disposed in the container such that the detector does not overlap the at least part of the X-ray tube when viewed in any of a predetermined direction in which the at least part of the X-ray tube and the source are aligned and directions perpendicular to the predetermined direction.

4. An X-ray generator comprising:
an X-ray tube configured to cause an X-ray beam to be generated;
a source configured to generate a voltage to be applied to the X-ray tube;
a container storing at least part of the X-ray tube; and
a first insulator that is liquid, the first insulator being sealed in the container, the first insulator covering the at least part of the X-ray tube,
wherein the container is provided with a discharge port through which an inside of the container and an outside of the container are in communication with each other.

5. The X-ray generator according to claim 4, further comprising:
a pipe connected to the discharge port; and
an open and shut part provided to the pipe, the open and shut part being configured to bring an inside of the pipe into an open state or a shut state.

6. An X-ray generator comprising:
an X-ray tube configured to cause an X-ray beam to be generated;
a source configured to generate a voltage to be applied to the X-ray tube;
a container storing at least part of the X-ray tube; and
a first insulator that is liquid, the first insulator being sealed in the container, the first insulator covering the at least part of the X-ray tube,
wherein at least part of the container is made of a material that allows light having a predetermined wavelength to travel through the material.

7. The X-ray generator according to claim 6, wherein the at least part of the container includes a plurality of parts located on both sides of the first insulator in a predetermined direction.

8. The X-ray generator according to claim 1, wherein
the source includes: a second insulator; and a circuit embedded in the second insulator, and
the circuit includes: a first voltage section configured to receive a first voltage from outside; a booster configured to boost the first voltage to a second voltage as the voltage; and a second voltage section configured to output the second voltage to the X-ray tube.

9. The X-ray generator according to claim 1, wherein
the source includes a circuit including: a first voltage section configured to receive a first voltage from outside; a booster configured to boost the first voltage to a second voltage as the voltage; and a second voltage section configured to output the second voltage to the X-ray tube,
the container further stores the circuit, and
the first insulator further covers the circuit.
